(19) United States
(12) Patent Application Publication
(10) Pub. No.: US 2015/0062435 A1
(43) Pub. Date: Mar. 5, 2015

(54) VIDEO SIGNAL PROCESSING DEVICE AND VIDEO SIGNAL PROCESSING METHOD

(71) Applicant: Samsung Electronics Co., Ltd., Suwon-si (KR)

(72) Inventor: Kiho Lee, Suwon-si (KR)

(73) Assignee: Samsung Electronics Co., Ltd., Suwon-si (KR)

(21) Appl. No.: 14/251,927

(22) Filed: Apr. 14, 2014

(30) Foreign Application Priority Data
Sep. 2, 2013 (KR) 10-2013-0105008

(51) Int. Cl. H04N 5/14

(52) U.S. Cl. CPC H04N 5/14
USPC 348/572

(57) ABSTRACT

A video signal processing device may include a signal converter configured to generate a video output signal based on a video input signal and a reference signal, a reference signal generator configured to generate the reference signal. The reference signal may be adjusted to accommodate changes in the video input signal.

### CROSS-REFERENCE TO RELATED APPLICATIONS

This US non-provisional patent application claims priority under 35 USC §119 to Korean Patent Application No. 10-2013-0105008, filed on Sep. 2, 2013, the entirety of which is hereby incorporated by reference.

### BACKGROUND OF THE INVENTION

1. Technical Field

Inventive concepts relate to video signal processing and, more particularly, to a video signal processing device and a video signal processing method to compensate level change of a video signal.

2. Discussion of Related Art

Digital video equipment, such as a digital television, which has been widely used in recent years, includes an analog front end (hereinafter referred to as “AFE”) circuit to receive an analog video signal and to output a digital video signal. The AFE circuit includes an analog-to-digital converter (hereinafter referred to as “ADC”) for converting an analog video signal to a digital video signal.

A level of an analog video signal may change due to various causes. When the level of the analog video signal changes, the level of the analog video signal may lie outside of a critical level range for processing by an analog to digital converter (ADC). Information corresponding to a portion lying outside the range of the ADC may be lost during signal processing.

An analog front end (AFE) circuit may include a clamp circuit to compensate level changes of an analog video signal. The clamp circuit may employ a capacitor having high capacitance connected to a terminal to which the analog video signal is input. The capacitor is connected to keep a level of an analog signal in a back porch interval constant.

However, the connection of the capacitor causes circuit complexity and circuit fabrication cost to increase. Typical digital video equipment is not configured to receive only one analog video signal. Alternatively, for user's convenience, the digital video equipment is configured to receive a plurality of analog video signals corresponding to various types of modes. Accordingly, when a plurality of channels is implemented to receive the plurality of analog video signals and a capacitor is connected in each of the plurality of channels, circuit complexity, circuit scale, and circuit fabrication cost is significantly increased.

### SUMMARY OF THE INVENTION

Exemplary embodiments in accordance with principles of inventive concepts include a video signal processing device that includes, a signal converter configured to generate a video output signal based on a video input signal and a reference signal; and a reference signal generator configured to generate the reference signal that is responsive to a level change of the video input signal.

Exemplary embodiments in accordance with principles of inventive concepts include a video signal processing device wherein the signal converter includes an analog-to-digital converter configured to receive a differential signal, and wherein the differential signal is constituted by the video input signal and the reference signal.

Exemplary embodiments in accordance with principles of inventive concepts include a video signal processing device comprising an offset controller configured to detect a change in the level of the video input signal provided to a position in which an observation signal included in the video output signal is outputted based on the observation signal and a signal corresponding to the position in which the observation signal is outputted, and to generate an offset signal when the level of the video input signal changes.

Exemplary embodiments in accordance with principles of inventive concepts include a video signal processing device wherein the signal converter generates the observation signal based on a signal in a back porch interval of the video input signal.

Exemplary embodiments in accordance with principles of inventive concepts include a video signal processing device wherein the offset controller samples the video output signal, according to a clock signal, to determine whether there is change in the level of the video input signal.

Exemplary embodiments in accordance with principles of inventive concepts include a video signal processing device wherein the offset controller detects a change in the level of the video input signal based on whether there is change in a code value of the observation signal.

Exemplary embodiments in accordance with principles of inventive concepts include a video signal processing device wherein the offset controller detects an increase in the video input signal when the code value of the observation signal increases, and detects a decrease in the level of the video input signal when the code value of the observation signal decreases.

Exemplary embodiments in accordance with principles of inventive concepts include a video signal processing device wherein the offset signal includes information corresponding to whether at least one of the code value of the observation signal and the level of the video input signal increases or decrease and information corresponding to an increased or decreased amount of the code value of the observation signal.

Exemplary embodiments in accordance with principles of inventive concepts include a video signal processing device wherein the reference signal generator generates the reference signal having a level adjusted based on the offset signal.

Exemplary embodiments in accordance with principles of inventive concepts include a video signal processing device wherein the reference signal generator generates the reference signal having a level increased by a value corresponding to the increased amount of the code value of the observation signal when the level of the video input signal increases, and generates the reference signal having a level decreased by a value corresponding to the decreased amount of the code value of the observation signal when the level of the video input signal decreases.

Exemplary embodiments in accordance with principles of inventive concepts include a video signal processing method including, generating a first video output signal based on a video input signal and a reference signal, determining whether there is change in a level of the video input signal based on an observation signal included in the first video output signal, generating a reference signal having a level adjusted to correspond with an amount of level change of the video input signal when the level of the video input signal changes, and generating a second video output signal based on the video input signal and the reference signal having the adjusted level.

Exemplary embodiments in accordance with principles of inventive concepts include a video signal processing method wherein determining includes determining whether there is change in the level of the video input signal based on whether there is change in a code value of the observation signal.

Exemplary embodiments in accordance with principles of inventive concepts include wherein it is determined that the level of the video input signal increases when the code value of the observation signal increases, and it is determined that the level of the video input signal decreases when the code value of the observation signal decreases.

Exemplary embodiments in accordance with principles of inventive concepts include a video signal processing method further comprising generating an offset signal including information corresponding to whether at least one of the code value of the observation signal and the level of the video input signal increases or decrease and information corresponding to an increased or decreased amount of the code value of the observation signal, wherein the generating the reference signal includes generating the reference signal having a level adjusted based on the offset signal.

Exemplary embodiments in accordance with principles of inventive concepts include a video signal processing method wherein the generating the reference signal includes generating the reference signal having a level increased by a value corresponding to the increased amount of the code value of the observation signal when the level of the video input signal increases, and includes generating the reference signal having a level decreased by a value corresponding to the decreased amount of the code value of the observation signal when the level of the video input signal decreases.

Exemplary embodiments in accordance with principles of inventive concepts include a method, including receiving an analog video signal, generating an adjustable reference signal, converting the analog video signal to a digital signal, using the adjustable reference signal in the analog-to-digital conversion; and adjusting the reference signal according to variations in non-image a portion of the analog video signal.

Exemplary embodiments in accordance with principles of inventive concepts include a method wherein the non-image portion of the analog video signal is in the blanking interval.

Exemplary embodiments in accordance with principles of inventive concepts include a method wherein the reference signal voltage is increased or decreased with increasing or decreasing values, respectively, of a back porch segment of the blanking interval.

Exemplary embodiments in accordance with principles of inventive concepts include a method wherein the reference signal level is set between upper and lower levels of the analog-to-digital converter's input range.

Exemplary embodiments in accordance with principles of inventive concepts include a method wherein reference signal is adjusted according to a digitally-converted value of an analog output signal, the analog video input signal is a differential signal based on an analog video signal and a reference signal, and the reference signal is adjusted according to an adjustment signal from a lookup table that correlates values of video signal back porch values to adjustment values.

### BRIEF DESCRIPTION OF THE DRAWINGS

FIG. 1 is a block diagram illustrating a configuration of a video signal processing device in accordance with principles of inventive concepts.

FIG. 2 is a block diagram illustrating other configuration of a video signal processing device in accordance with principles of inventive concepts.

FIG. 3 is other block diagram illustrating other configuration of a video signal processing device in accordance with principles of inventive concepts.

FIG. 4 is another block diagram illustrating other configuration of a video signal processing device in accordance with principles of inventive concepts.

FIG. 5 is a conceptual diagram illustrating a relationship between a video input signal and a video output signal.

FIGS. 6 and 7 are conceptual diagrams illustrating a procedure that a level of a reference signal increases according to some embodiments in accordance with principles of inventive concepts when a level of a video input signal increases.

FIGS. 8 and 9 are conceptual diagrams illustrating a procedure that a level of a reference signal decreases according to some embodiments in accordance with principles of inventive concepts when a level of a video input signal decreases.

FIG. 10 is a flowchart illustrating a video signal processing method in accordance with principles of inventive concepts.

FIG. 11 is other flowchart illustrating a video signal processing method in accordance with principles of inventive concepts.

FIG. 12 is a block diagram illustrating a configuration of a video output system in accordance with principles of inventive concepts.

### DETAILED DESCRIPTION

Various exemplary embodiments will be described more fully hereinafter with reference to the accompanying drawings, in which exemplary embodiments are shown. Exemplary embodiments may, however, be embodied in many different forms and should not be construed as limited to exemplary embodiments set forth herein. Rather, these exemplary embodiments are provided so that this disclosure will be thorough, and will convey the scope of exemplary embodiments to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. The term “or” is used in an inclusive sense unless otherwise indicated.

It will be understood that, although the terms first, second, third, for example. may be used herein to describe various elements, components, regions, layers and/or sections, these elements, components, regions, layers and/or sections should not be limited by these terms. These terms are only used to distinguish one element, component, region, layer or section from another region, layer or section. In this manner, a first element, component, region, layer or section discussed below could be termed a second element, component, region, layer or section without departing from the teachings of exemplary embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. In this manner, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. In this manner, exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. In this manner, the regions illustrated in the figures are schematic in nature and their shapes are not intended to illustrate the actual shape of a region of a device and are not intended to limit the scope of exemplary embodiments.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly faunal sense unless expressly so defined herein.

Hereinafter, exemplary embodiments in accordance with principles of inventive concepts will be explained in detail with reference to the accompanying drawings.

Variation in video signal levels within a video frame correspond to values of image information to be displayed. The values of a video signal may vary within upper and lower limits of a video signal range in a frame. For proper image reproduction, the upper and lower limits should remain constant from frame to frame. However, that is not always the case, and, as a result, errors may be introduced into the reproduction of video images.

If, for example, a video signal is to be converted from an analog signal to video values using an analog-to-digital converter (ADC), the input range of the ADC may be correlated with (for example, matched to) the range of the analog video signal in order to yield the best possible conversion results. However, if the video signal drifts upward or downward, higher or lower values, respectively, of the video signal could be clipped during conversion from analog to digital signal.

In exemplary embodiments of a method and apparatus in accordance with principles of inventive concepts an adjustable reference signal is employed to match input video signal voltage values to a video signal converter input in order to avoid signal clipping should the input video signal travel outside its nominal, or baseline, range. A portion of the received video signal may be monitored to determine whether the video signal levels are at a nominal level or have drifted from the nominal level. In exemplary embodiments in accordance with principles of inventive concepts a portion of the video signal that should remain at a constant value, regardless of video content, is monitored to determine whether the signal is at a nominal value. That is, a portion of the signal that does not carry image information, such as a blanking signal or portion thereof, may be used by a system and method in accordance with principles of inventive concepts to determine whether the video signal has drifted, had noise introduced, or has otherwise moved from its nominal value and to adjust a reference signal used in analog-to-digital conversion accordingly. In exemplary embodiments, a portion of the blanking signal referred to as the back porch may be used as the signal, also referred to herein as the monitoring signal, by which excursions of the video signal may be determined.

In exemplary embodiments in accordance with principles of inventive concepts a video signal converter monitors the back porch of a video signal to determine whether it's voltage level has changed from a “baseline” value and adjusts a voltage reference signal used by an ADC in the conversion of the analog video signal to a digital value to maintain correlation between the video input signal and the input range of the video signal converter's ADC.

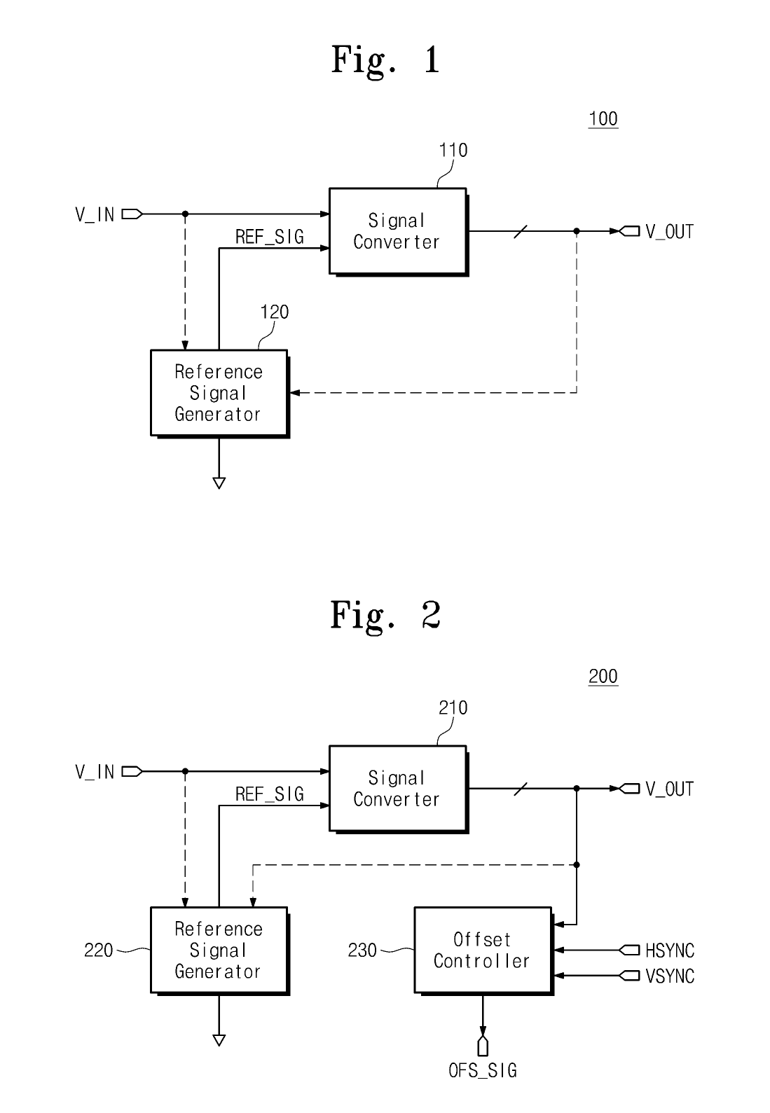

FIG. 1 is a block diagram of an exemplary embodiment of a video signal processing device in accordance with principles of inventive concepts. Video signal processing device 100 includes a signal converter 110 and a reference signal generator 120. The signal converter 110 may receive a video input signal V_IN and a reference signal REF_SIG and may generate a video output signal V_OUT, based on the video input signal V_IN and the reference signal REF_SIG.

The reference signal REF_SIG has a level which is referenced when the video output signal V_OUT is generated based on the video input signal V_IN. For instance, a video output signal V_OUT generated based on a signal, included in the video input signal V_IN, having the same level as the reference signal REF_SIG may have a fixed binary code value irrespective of level change of the video input signal V_IN. The level of the reference signal REF_SIG may be adjustable. In addition, a binary code having a code value corresponding to a level of the reference signal REF_SIG may be set at a value that accommodates excursions of input signal baseline values, for example. A baseline level of the reference signal REF_SIG and the code value corresponding to the level of the reference signal REF_SIG may be fixed to a value during designing of a device, during testing, or at another time, for example.

The reference signal generator 120 may generate the reference signal REF_SIG, which may be adjustable. Reference signal generator 120 may be implemented in the form of a variable voltage source that may adjust a level of an output voltage. The reference signal REF_SIG generated by the reference signal generator 120 may be provided to the signal converter 110.

When the baseline level of the video input signal V_IN changes, the reference signal generator 120 may generate a reference signal REF_SIG having a level adjusted to correspond with an amount of level change of the video input signal V_IN. That is, the reference signal may be adjusted according to excursions of a non-image portion of the video signal from a baseline level. Image portions of the video signal may change during each frame, but accommodation of video signal levels from a baseline level are accommodated by a reference signal generator in accordance with principles of inventive concepts. The baseline level of video signal may also be referred to herein, simply, as the level of the video input signal. When the level of the video input signal V_IN changes, the level of the video input signal V_IN may lie in outside of a critical level range required for generating a proper video output signal V_OUT. If the reference signal REF_SIG is kept at the same level although the level of the video input signal V_IN changes, the video input signal V_IN having a level lying in outside of the critical level range may be lost during generating of the video output signal V_OUT. Accordingly, when the level of the video input signal V_IN changes, the level of the reference signal REF_SIG may be adjusted in accordance with principles of inventive concepts to correspond with the amount of level change of the video input signal V_IN. The reference signal generator 120 may adjust the level of the reference signal REF_SIG.

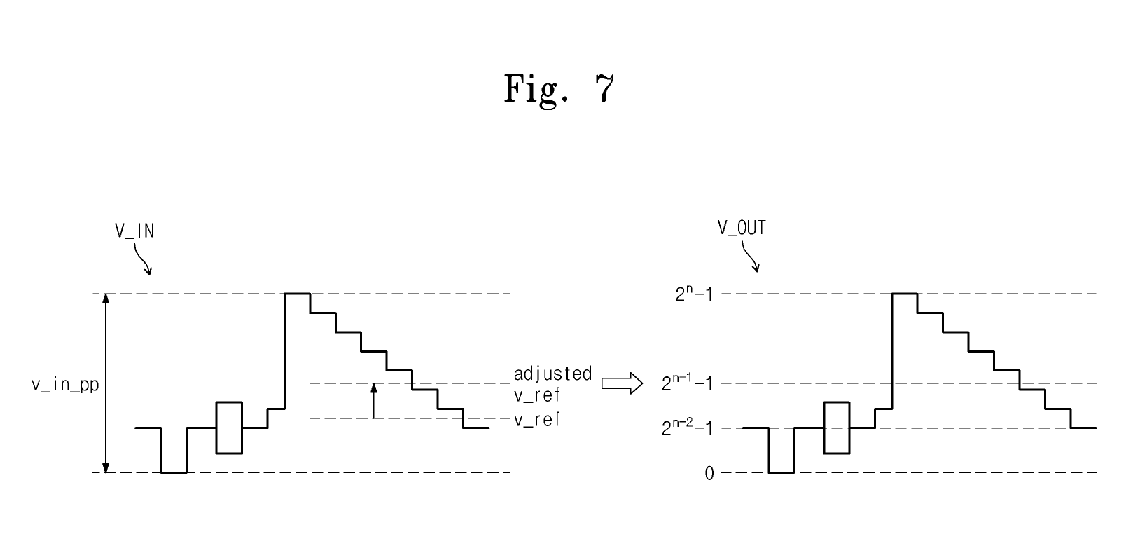

The reference signal generator 120 may refer to the video input signal V_IN to adjust the level of the reference signal REF_SIG. Alternatively, the reference signal generator 120 may refer to the video output signal V_OUT to indirectly determine whether the level of the video input signal V_IN changes. A procedure of adjusting the level of the reference signal REF_SIG will be described in greater detail in the discussion related to FIGS. 5 to 9.

In some embodiments, the signal converter 110 may include an analog-to-digital converter (hereinafter referred to as “ADC”). Particularly, the signal converter 110 may include an ADC that receives a differential signal to minimize an effect of noise. If the signal converter 110 includes the ADC that receives a differential signal, the video input signal V_IN and the reference signal REF_SIG may constitute a differential signal.

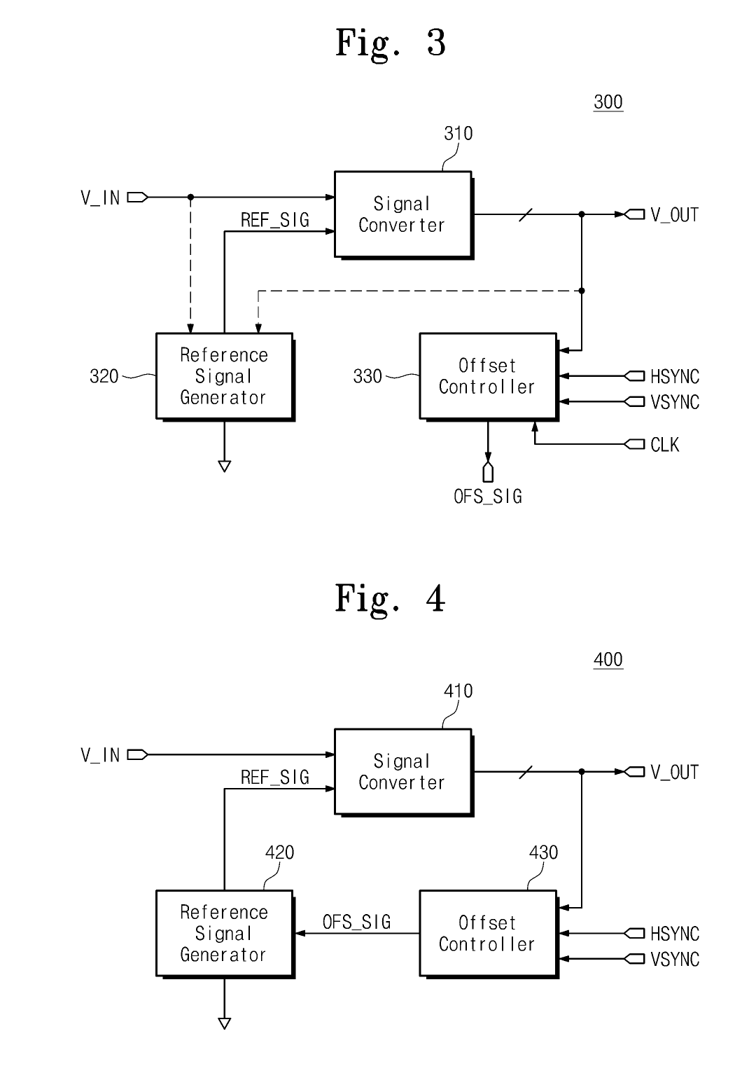

FIG. 2 is a block diagram illustrating an exemplary embodiment of a video signal processing device in accordance with principles of inventive concepts. The video signal processing device 200 may include a signal converter 210, a reference signal generator 220, and an offset controller 230. The structures and the functions of the signal converter 210 and the reference signal generator 220 may include those of the signal converter 110 and the reference signal generator 120 of FIG. 1, respectively. In the description of FIG. 2, description of sections previously described in the discussion related to FIG. 1 will not be repeated here.

The offset controller 230 may receive a video output signal V_OUT. In addition, the offset controller 230 may receive a signal corresponding to a position of a video device where the video output signal V_OUT is outputted. For instance, the offset controller 230 may receive a signal HSYNC indicating a position in a horizontal direction and a signal VSYNC indicating a position in a depth, or height, direction.

The offset controller 230 may refer to the video output signal V_OUT, especially an observation signal. The observation signal, which may be a non-image portion of the video signal, such as a portion of the blanking interval commonly referred to as the “front porch” or “back porch”, is set to determine whether the level of the video input signal V_IN changes. That is, in exemplary embodiments in accordance with principles of inventive concepts, a non-image portion of a video signal, such as the front porch or the back porch, may be used as an indicator of the video signal's baseline value and a system and method in accordance with principles of inventive concepts may adjust a reference signal in order to accommodate excursions in the video signal from a baseline value using such a non-image portion of the video signal. In some embodiments, the determining whether the level of the video input signal V_IN changes is performed based on whether a code value of the observation signal changes. That is, when the code value (also referred to herein as the digital equivalent, or digitally converted value) of the observation signal changes, it may be determined that the level of the video input signal V_IN changes. The “code value” may be a binary representation of a video input signal value or may be a decimal or other representation of such a value, for example.

The observation signal may be generated based on a signal, which may be identified to be set as a monitoring target, among the video input signal V_IN. For instance, the signal converter 210 may generate an observation signal based on a signal in a back porch interval of the video input signal V_IN. There is a blanking interval, which does not include video information, between signals including video information among analog video signals. The blanking interval includes a synchronization pulse to synchronize an output of analog video signals. A front portion of the synchronization pulse in the blanking interval is referred to as a front porch interval, and a back portion of the synchronization pulse in the blanking interval is referred to as a back porch interval. In the video input signal V_IN, for instance, a signal in the back porch interval may be identified to be set as the monitoring target. However, this is merely exemplary and any identifiable signal such as a signal in a front porch interval may be set as the monitoring target.

The offset controller 230 may monitor whether there is change in a code value of the observation signal generated based on a signal in the back porch interval of the video input signal V_IN. The change in the code value of the observation signal may mean change in the level of the signal in the back porch interval of the video input signal V_IN. That is, the change in the code value of the observation signal may mean change in the level of the overall video input signal V_IN (also referred to herein as “baseline” or “nominal” level). Accordingly, the offset controller 230 may determine whether there is change in the level of the video input signal V_IN based on whether there is change in the code value of the observation signal included in the video output signal V_OUT.

Offset controller 230 may determine whether there is change in the level of the video input signal V_IN provided to a position where the observation signal is outputted, by referring to the observation signal and a signal corresponding to the position where the observation signal is output to a video device. When the code value of the observation signal increases, the offset controller 230 may determine that the level of the video input signal V_IN increases. On the other hand, when the code value of the observation signal decreases, the offset controller 230 may determine that the level of the video input signal V_IN decreases. For example, when the value of the back porch of the blanking interval increases, the offset controller 230 may determine that the entire video signal has shifted in a positive direction and, when the value of the back porch of the blanking interval decreases, the offset controller 230 may determine that the entire video signal has shifted in a negative direction.

When the level of the video input signal V_IN changes, the offset controller 230 may generate an offset signal OFS_SIG. The offset signal OFS_SIG may be generated to include information with respect to level change of the video input signal V_IN. For instance, the offset signal OFS_SIG may be generated to include information corresponding to whether the code value of the observation signal increases or decreases. Alternatively, the offset signal OFS_SIG may be generated to include information corresponding to whether the level of a video input signal V_IN increases or decreases. In addition, the offset signal OFS_SIG may be generated to include information corresponding to an increased or decreased amount of the code value of the observation signal. Offset signal OFS_SIG may be generated in the form including various types of information simultaneously.

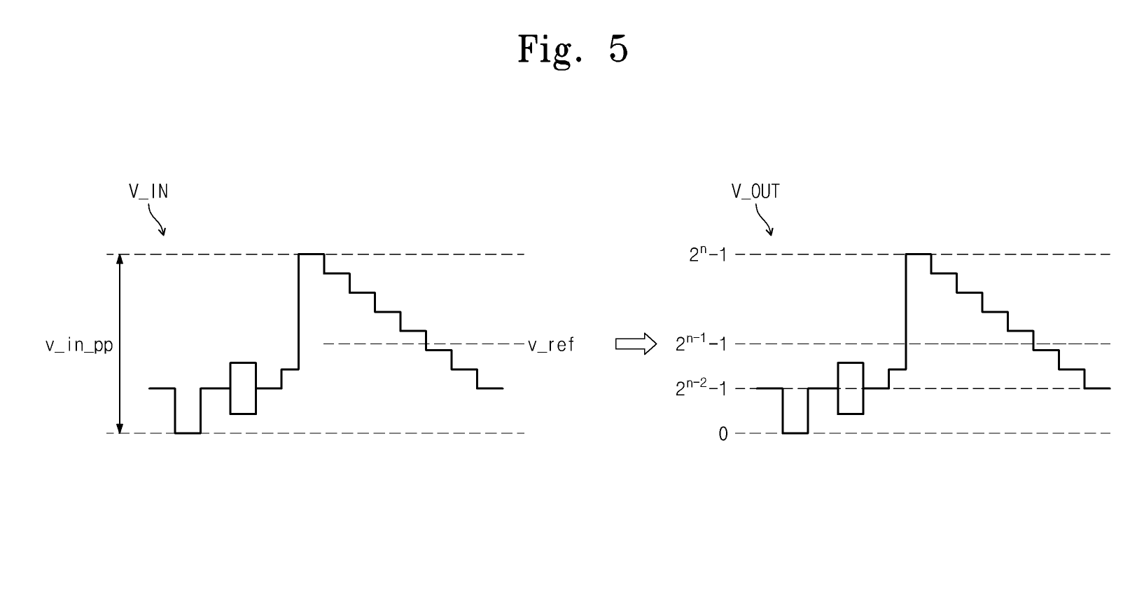

FIG. 3 is a block diagram of an exemplary embodiment of a video signal processing device in accordance with principles of inventive concepts. The video signal processing device 300 includes a signal converter 310, a reference signal generator 320, and an offset controller 330. The structures and the functions of the signal converter 310, the reference signal generator 320, and the offset controller 330 may include those of the single converter 210, the reference signal generator 220, and the offset controller 230 of FIG. 2, respectively. In the description of FIG. 3, sections described in reference to the discussion of FIG. 2 will not be repeated.

The offset controller 330 may receive not only the video output signal V_OUT and a signal corresponding to a position where the video output signal V_OUT is outputted to a video device, but also a clock signal CLK. The offset controller 330 may receive the clock signal CLK for digital signal processing. The offset controller 330 may sample the video output signal V_OUT at a rising edge, at a falling edge, or at both of the rising and falling edges of the clock signal CLK to refer to the observation signal included in the video output signal V_OUT.

The offset controller 330 may sample the video output signal V_OUT according to the clock signal CLK for a predetermined time. That is, the offset controller 330 need not sample the video output signal V_OUT at all edges of the clock signal CLK, but may sample the video output signal V_OUT only for a set time such as one-time or three-time cycle of the clock signal CLK, according to design choice. According to a result of the sampling, the offset controller 330 may determine whether there is change in the level of the video input signal V_IN and may generate the offset signal OFS_SIG.

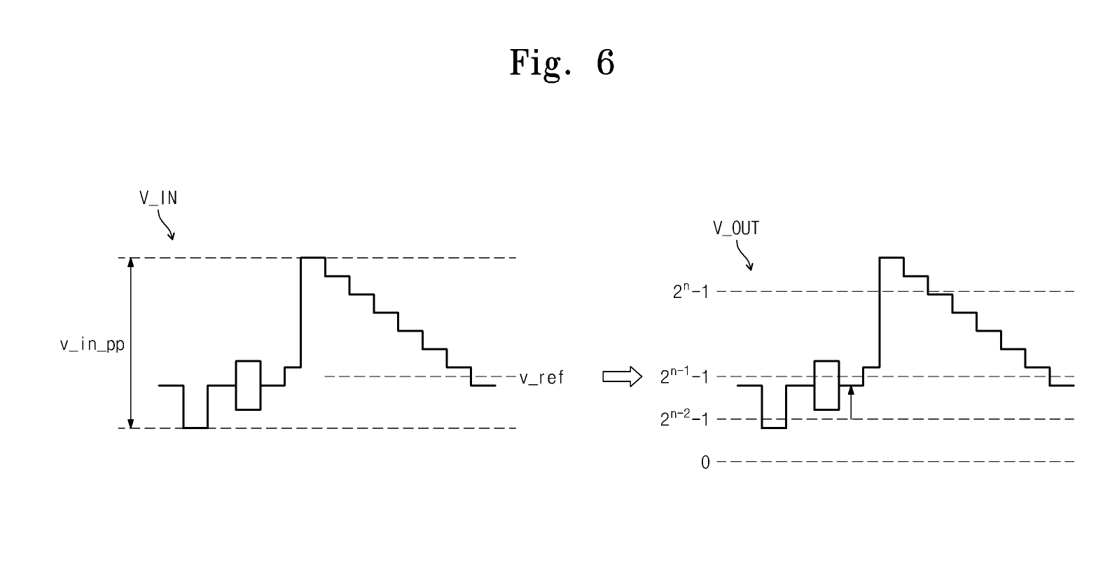

FIG. 4 is a block diagram of an exemplary embodiment of a video signal processing device in accordance with principles of inventive concepts. The video signal processing device 400 includes a signal converter 410, a reference signal generator 420, and an offset controller 430. The structures and the functions of the signal converter 410, the reference signal generator 420, and the offset controller 430 may include those of the single converter 210, the reference signal generator 220, and the offset controller 230 of FIG. 2, respectively. In the description of FIG. 4, sections described in the discussion of FIG. 2 will not be repeated.

Offset controller 430 may determine whether there is change in the level of the video input signal V_IN based on whether there is change in the code value of the observation signal (for example, whether the digitized value of the signal's back porch changes). The offset controller 430 may determine that the level of the video input signal V_IN increases when the code value of the observation signal increases. On the other hand, the offset controller 430 may determine that the level of the video input signal V_IN decreases when the code value of the observation signal decreases.

In the above embodiment, the offset signal OFF_SIG generated by the offset controller 430 may include information corresponding to whether the code value of the observation signal or the level of the video input signal V_IN increases or decreases. In addition, the offset signal OFS_SIG may be generated to include information corresponding to the increased or decreased amount of the code value of the observation signal.

Furthermore, the reference signal generator 420 may receive the offset signal OFS_SIG. The reference signal generator 420 may generate the reference signal REF_SIG having a level adjusted based on the offset signal OFS_SIG. More specifically, the reference signal generator 420 may generate the reference signal REF_SIG having a level increased by a value corresponding to the increased amount of the code value of the observation signal when the level of the video input signal V_IN increases (i.e., the received offset signal OFS_SIG includes information that the code value of the observation signal or the level of the video input signal V_IN increases). On the other hand, the reference signal generator 420 may generate the reference signal REF_SIG having a level decreased by a value corresponding to the decreased amount of the code value of the observation signal when the level of the video input signal V_IN decreases (i.e., the received offset signal OFS_SIG includes information that the code value of the observation signal or the level of the video input signal V_IN decreases).

The reference signal generator 420 may extract information corresponding to the increased or decreased amount of the code value of the observation signal from the offset signal OFS_SIG. In exemplary embodiments, the increased or decreased amount of the code value of the observation signal may be a digital value. Alternatively, the increased or decreased amount of the level of the reference signal REF_SIG may be an analog value, in which case, the reference signal generator 420 may include a digital-to-analog converter (DAC) for converting a digital value to an analog value, or the reference signal generator 420 may include a look-up table to store correspondence information between a digital value and an analog value, for example. The reference signal generator 420 may convert the increased or decreased amount of the code value of the observation signal to the amount of the adjusted level of the reference signal REF_SIG. The reference signal generator 420 may increase or decrease the level of the reference signal REF_SIG by the amount of the adjusted level of the reference signal REF_SIG.

FIG. 5 is a conceptual diagram illustrating a relationship between a video input signal and a video output signal. In the left diagram of FIG. 5, shown is a video input signal V_IN where a difference between maximum level and minimum level is v_in_pp. A reference signal may have a level of v_ref. A negative excursion in the signal level on the leftmost side of the figure may correspond to a sync region, for example, followed by a rectangular area corresponding to a reference burst, then a back porch region. In FIG. 5, it is shown that the level of the reference signal lies in the center of the maximum level and the minimum level of the video input signal V_IN. However, this is just exemplary for the convenience of explanation. The level v_ref of the reference signal may be set to have any level, such as the level of a reference sync amplitude, for example. A video input signal V_IN may be divided into a plurality of level intervals. A video output signal V_OUT may be generated by converting a signal included in each of the plurality of level intervals to a corresponding binary code.

In a right diagram of FIG. 5, shown is an output signal V_OUT having an n-bit binary code. A video output signal V_OUT may have a code value from 0 to (2ⁿ−1) according to the corresponding level of the video input signal V_IN. The code value may refer to a value obtained when a binary code is expressed as a decimal number. For instance, a video output signal V_OUT generated based on a video input signal V_IN having the maximum level may have a code value of (2ⁿ−1). A video output signal V_OUT generated based on a video input signal V_IN having the minimum level may have a code value of “0”. In addition, a video output signal V_OUT generated based on a video input signal V_IN having the same level as a reference signal may have a code value of (2ⁿ⁻¹−1). The video output signal V_OUT generated based on the video input signal V_IN may have a code value differing from (2ⁿ⁻¹−1).

When the video output signal V_OUT has a 10-bit binary code, a video output signal V_OUT generated based on a video input signal V_IN having the maximum level may have a code value of 1023 (binary code of 1111111111). The video output signal V_OUT generated based on the video input signal V_IN having the same level as the reference signal may have a code value of 511 (binary code of 0111111111).

Hereinafter, it is assumed that an observation signal included in the video output signal V_OUT is generated based on a signal in a back porch interval of the video input signal V_IN. According to this assumption, an observation signal may have a code value of (2ⁿ⁻²-1), in an exemplary embodiment. For example, when the video output signal V_OUT has a 10-bit binary code, an observation signal may have a code value of 255 (binary code of 0011111111).

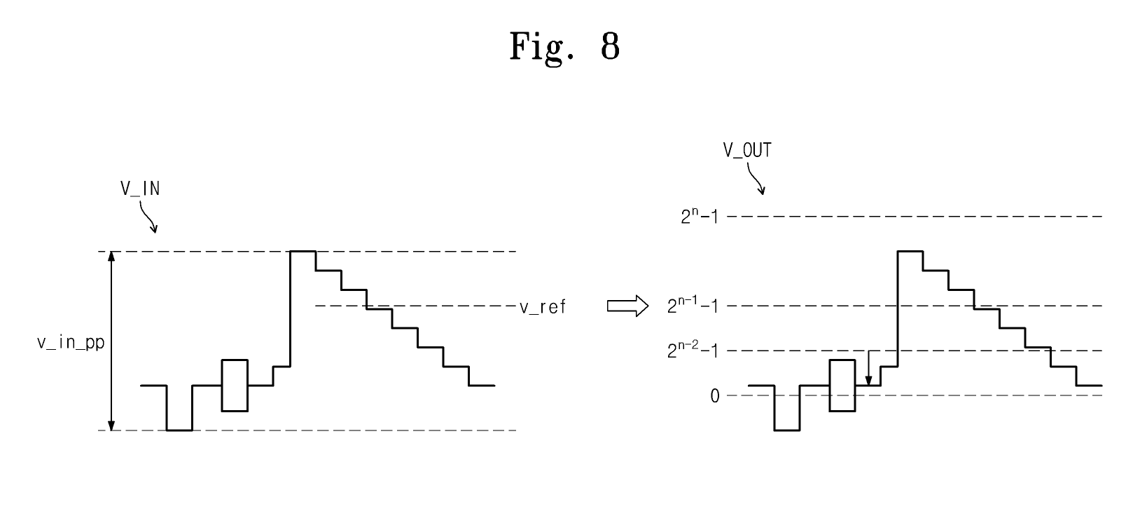

The description concerning FIGS. 6 to 9 will be given based on the assumption made in the description concerning FIG. 5.

FIGS. 6 and 7 are conceptual diagrams illustrating a procedure in accordance with principles of inventive concepts whereby the level of a reference signal is increased when a level (for example, the baseline level) of a video input signal increases.

In the left diagram of FIG. 6, shown is a video input signal V_IN having a level increased. Although the level of the video input signal V_IN changes, a signal having the same level as a reference signal may be converted to a video output signal V_OUT having a code value of (2ⁿ⁻¹−1). In a right diagram of FIG. 6, it can be noticed that a portion of the video input signal V_IN lies above a code value of (2ⁿ−1). The video input signal V_IN that lies above the code value of (2ⁿ−1) may be lost during generation of the video output signal V_OUT. This is an example of an upward shift in the baseline value of a video signal which a system and method in accordance with principles of inventive concepts accommodates, for example, by adjusting the value of a reference signal to track the shift in baseline value of the video signal.

By monitoring the code value of the observation signal, a determination may be made on whether the level of the video input signal V_IN increases. In this exemplary embodiment the observation signal has a code value of (2ⁿ⁻²−1) at the first time, however, the observation signal becomes to have a code value greater than (2ⁿ⁻²−1) due to increasing of the level of the video input signal V_IN. Since the code value of the observation signal increases, it may be determined that the level of the video input signal V_IN increases. Since it is determined that the level of the video input signal V_IN increases, a process to increase a level v_ref of a reference signal may be performed in accordance with principles of inventive concepts. That is, in order to avoid loss of information, a system and method in accordance with principles of inventive concepts may increase the level v_ref of the reference signal to a median value between the maximum level and the minimum level of the video input signal V_IN.

In a left diagram of FIG. 7, shown is an adjusted level adjusted v_ref that a reference signal has. A signal having the level adjusted v_ref same as the reference signal is still converted to the video output signal V_OUT having the code value of (2ⁿ⁻¹−1). Unlike the embodiment of FIG. 6, the video output signal V_OUT may be generated without loss of information in the embodiment of FIG. 7. This is because by adjusting the level v_ref of the reference signal to adjusted v_ref, the video output signals V_OUT having code values of (2ⁿ−1) and 0 may be generated based on the video input signals V_IN having the maximum level and the minimum level, respectively.

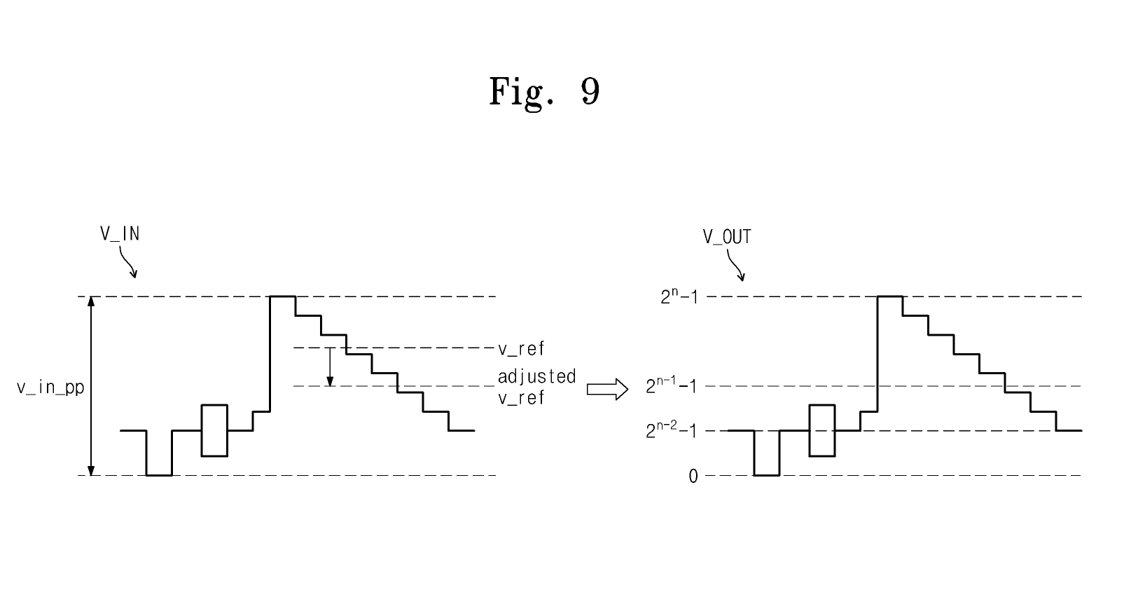

FIGS. 8 and 9 are conceptual diagrams illustrating a procedure that a level of a reference signal decreases according to some embodiments when a level of a video input signal decreases. In a left diagram of FIG. 8, shown is a video input signal V_IN having a level decreased. Although the level of the video input signal V_IN changes, a signal having the same level as a reference signal may be converted to a video output signal V_OUT having a code value of (2ⁿ⁻¹−1). In a right diagram of FIG. 8, it can be noticed that a portion of the video input signal V_IN lies below a code value of 0. The video input signal V_IN that lies below the code value of 0 may be lost during generation of the video output signal V_OUT. This is an example of a downward shift in the baseline value of a video signal which a system and method in accordance with principles of inventive concepts accommodates, for example, by adjusting the value of a reference signal to track the shift in baseline value of the video signal.

By monitoring the code value of the observation signal, a determination may be made on whether the level of the video input signal V_IN decreases. The observation signal has a code value of (2ⁿ⁻²−1) at the first time, however, the observation signal becomes to have a code value smaller that (2ⁿ⁻²−1) due to decreasing of the level of the video input signal V_IN. Since the code value of the observation signal decreases, it may be determined that the level of the video input signal V_IN decreases. Since it is determined that the level of the video input signal V_IN decreases, a process to decrease a level v_ref of a reference signal may be performed in accordance with principles of inventive concepts. That is, in order to avoid loss of information, a system and method in accordance with principles of inventive concepts may decrease the level v_ref of the reference signal to a value between the maximum level and the minimum level of the video input signal V_IN.

In the left diagram of FIG. 9, shown is an adjusted level adjusted v_ref. A signal having the level adjusted v_ref same as the reference signal is still converted to the video output signal V_OUT having the code value of (2ⁿ⁻¹−1). Unlike the embodiment of FIG. 8, the video output signal V_OUT may be generated without loss of information in the embodiment of FIG. 9. This is because by adjusting the level v_ref of the reference signal to adjusted v_ref in accordance with principles of inventive concepts, the video output signals V_OUT having code values of (2ⁿ−1) and 0 may be generated based on the video input signals V_IN having the maximum level and the minimum level, respectively. Although matching the peak-to-peak values of a video input signal to the input range of an ADC in accordance with principles of inventive concepts may be performed, as illustrated in these exemplary embodiments, the input range of the ADC may exceed the peak-to-peak value of the video signal, without introducing clipping.

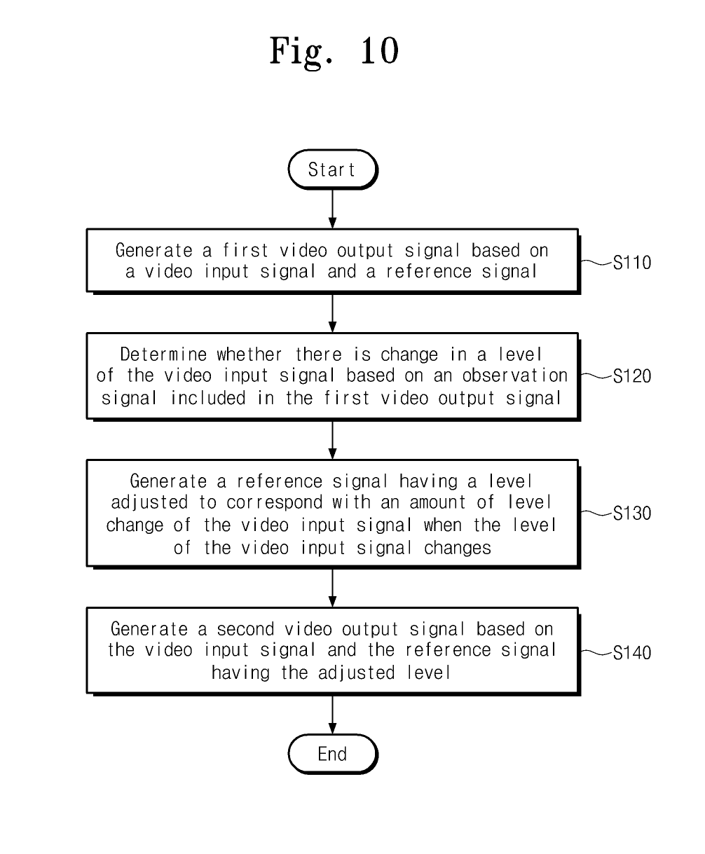

FIG. 10 is a flowchart illustrating an exemplary embodiment of a video signal processing method in accordance with principles of inventive concepts. In operation S110, a first video output signal may be generated based on a video input signal and a reference signal. A first video output signal, such as an observation signal, included in the first video output signal may be referred in the next operation S120.

In the operation S120, a determination may be made as to whether a level of the video input signal has changed. This determination may be based on an observation signal. In some exemplary embodiments, a determination may be made based on whether a code value of the observation signal changes. For example, when the code value of the observation signal increases or decreases, it may be determined that the level of the video input signal (the baseline, or nominal, level, for example) increases or decreases.

In accordance with principles of inventive concepts, the observation signal may be generated based on a signal, which may be identified to be set as a monitoring target, among the video input signal. For instance, the observation signal may be generated based on a signal in a back porch interval of the video input signal. In the video input signal, the signal in the back porch interval may be identified to be set as a monitoring target.

According to exemplary embodiments in accordance with principles of inventive concepts, it may be monitored whether there is change in the code value of the observation signal. The change in the code value of the observation signal may indicate a change in the level of the signal in a back porch interval of the video input signal. That is, the change in the code value of the observation signal may indicate a change in the level of the overall video input signal. Accordingly, the determination as to whether there is change in the level of the video input signal may be made based on whether there is change in the code value of the observation signal associated with the video output signal.

In exemplary embodiments, when the level of the video input signal changes, an offset signal may be generated to include information corresponding to whether the code value of the observation signal or the level of the video input signal increases or decreases. That is, the offset may compensate for changes in video input signal levels. The offset signal may be generated to further include information corresponding to an increased or decreased amount of the code value of the observation signal. When the level of the video input signal changes, the next operation S130 may be performed.

In the operation S130, the reference signal having a level adjusted to correspond with the amount of level change of the video input signal may be generated. That is, the level of the reference signal may be adjusted to correspond with the amount of level change of the video input signal. The reference signal having the adjusted level may be generated based on the offset signal generated in the operation S120, for example.

In operation S140, a second video output signal may be generated based on the video input signal and a reference signal having the adjusted level. As mentioned in the description related to FIGS. 5 to 9, when the level of the video input signal changes, information could be lost during generation of the first video output signal. However, in accordance with principles of inventive concepts the level of the reference signal may be adjusted to correspond with the amount of level change of the video input signal, and the second, that is, compensated, video output signal may be generated without loss of information although the level of the video input signal changes.

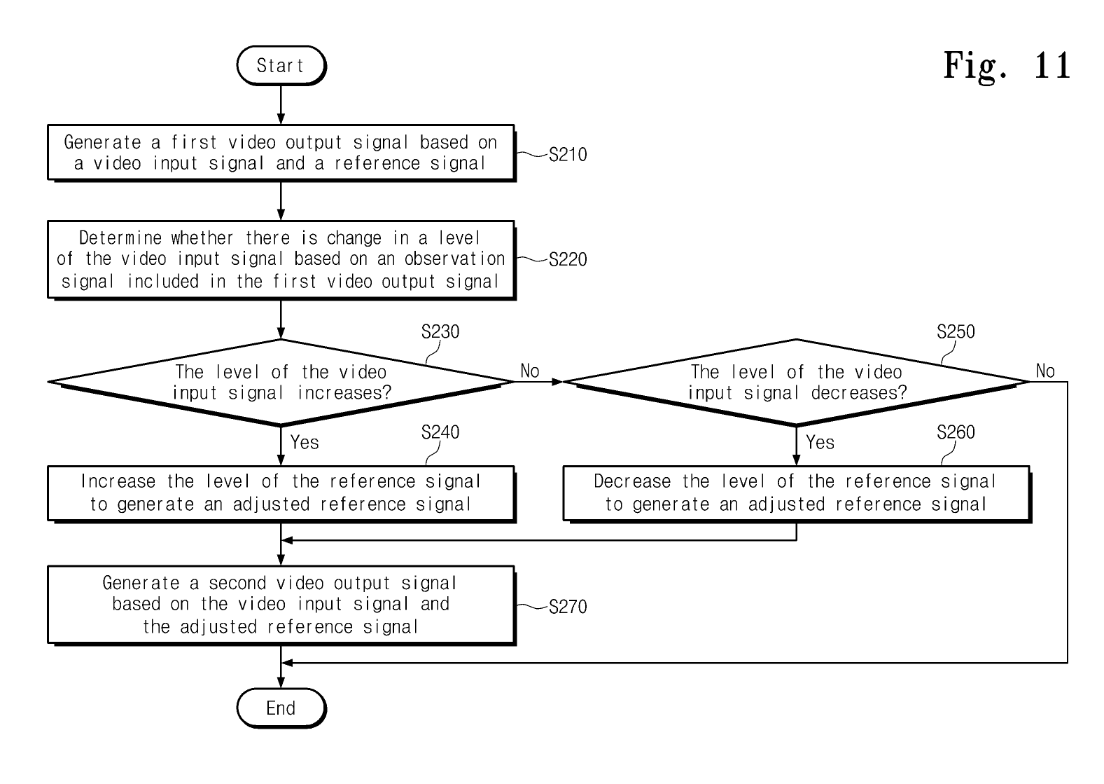

FIG. 11 is a flowchart illustrating an exemplary embodiment of a video signal processing method in accordance with principles of inventive concepts.

In operation S210, a first video output signal may be generated based on a video input signal and a reference signal. A first video output signal, especially an observation signal included in the first video output signal, for example, a portion of the video output signal such as the back porch, may be referred in the next operation S220.

In the operation S220, a determination may be made as to whether a level of the video input signal has changed. The determination may be based on an observation signal. In some embodiments, a determination may be made based on whether a code value of the observation signal changes. For example, when the code value of the observation signal increases or decreases, it may be determined that the level of the video input signal increases or decreases. The process of the operation S220 may include that of the operation S120 of FIG. 10. In operation S220, sections described in the discussion related to FIG. 10 will not be repeated.

In operation S230, determination may be made as to whether the level of the video input signal has increased. When the level of the video input signal increases, operation S240 may be performed. When the level of the video input signal does not increase, operation S250 may be performed.

In the operation S240, a reference signal having an adjusted level may be generated by increasing the level of the reference signal in accordance with principles of inventive concepts. That is, the reference signal generated in the operation S240 may have an increased level as compared to the reference signal generated in the operation S210. The level of the reference signal generated in the operation S240 may increase by a value corresponding to the increased amount of the code value of the observation signal.

In the operation S250, determination may be made as to whether the level of the video input signal decreased. When the level of the video input signal has decreased, operation S260 may be performed. When the level of the video input signal does not increase or decrease, the video signal processing method may proceed to end.

In the operation S260, the reference signal having an adjusted level may be generated by decreasing the level of the reference signal. That is, the reference signal generated in the operation S260 may have a decreased level as compared to the reference signal generated in the operation S210. The level of the reference signal generated in the operation S260 may decrease by a value corresponding to the decreased amount of the code value of the observation signal. By “corresponding” it is not meant that the values are increased the same about, only that the increase or decrease in reference signal accommodates the increase or decrease in the value of the video signal.

In operation S270, a second video output signal may be generated based on the video input signal and the reference signal having the adjusted level. As mentioned in the description concerning FIGS. 5 to 9, when the level of the video input signal changes, information could be lost during generation of the first video output signal. However, when the level of the reference signal is adjusted in accordance with principles of inventive concepts to correspond with the amount of level change of the video input signal, the second video output signal may be generated without loss of information although the level of the video input signal changes.

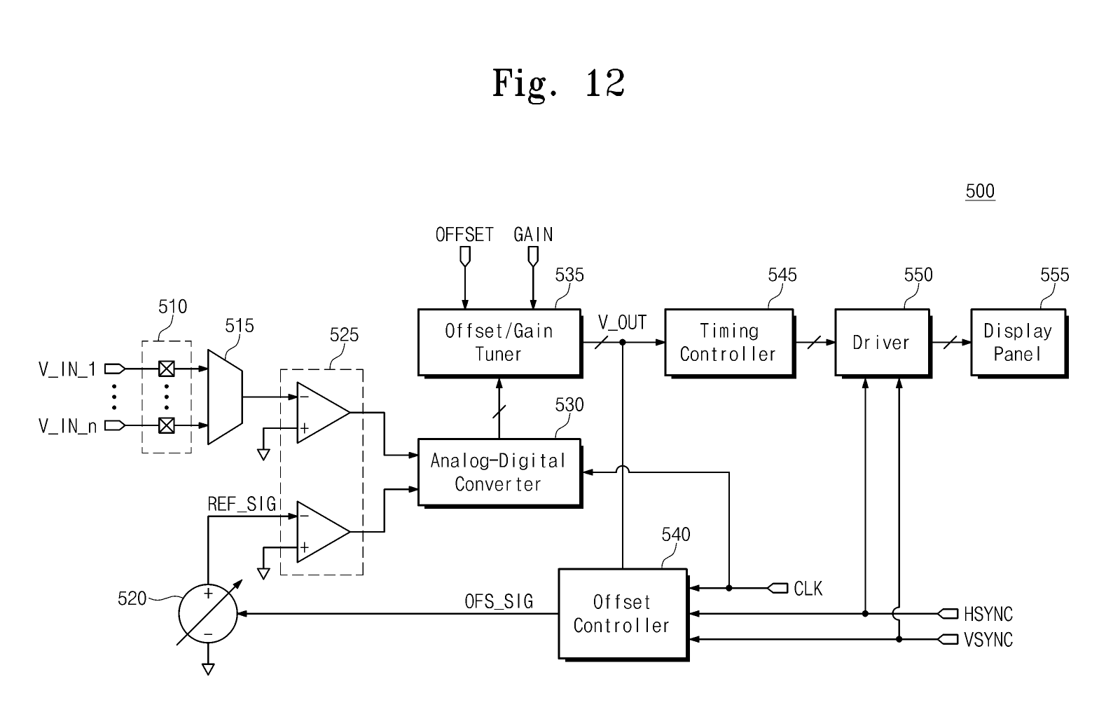

According to exemplary embodiments in accordance with principles of inventive concepts, a clamp circuit incorporated in an analog front end (AFE) circuit may be replaced with a circuit or unit that generates a reference signal having a level adjusted to correspond with (that is, compensate for) the amount of level change of a video input signal. In exemplary embodiments in accordance with principles of inventive concepts, a capacitor having high capacitance may that otherwise may be required may be eliminated from a terminal to which a video input signal is inputted. Elimination of such a capacitor may reduce the complexity of a printed circuit board (PCB) design pattern and the scale of the PCB or the complexity and scale of a circuit may be reduced. In addition, if the capacitor is eliminated, the manufacturing cost of the PCB or the circuit device may be reduced. In particular, the effect according to exemplary embodiments of inventive concepts may be enhanced when a plurality of channels are formed to receive a plurality of video input signals. A video output system receiving a plurality of video input signals will now be described with reference to FIG. 12.

FIG. 12 is a block diagram illustrating a configuration of a video output system such as may include an exemplary embodiment of a video converter in accordance with principles of inventive concepts. The video output system 500 includes a pad 510, a multiplexer 515, a reference signal generator 520, a buffer 525, an analog-digital converter (ADC) 530, an offset/gain tuner 535, an offset controller 540, a timing controller 545, a driver 550, and a display panel 555.

For user convenience, the video output system 500 may receive a plurality of video input signals V_IN_1, . . . , V_IN_n corresponding various types of modes. For instance, the video output system 500 may receive different video input signals V_IN_1, . . . , V_IN_n when it operates in a first external input mode and when it operates in a second external input mode. Alternatively, the video output system 500 may receive different video input signals V_IN_1, . . . , V_IN_n through a plurality of input ports such as an input port that may be located on difference surfaces of a display device, such as a back surface and an input port of a side surface. In a device receiving a plurality of video input signals such as the video output system 500 in FIG. 12, the effect benefits obtained by removing a capacitor by employing a system and method in accordance with principles of inventive concepts may be particularly pronounced.

The pad 510 may receive the video input signals V_IN_1, . . . , V_IN_n. Each pad 510 may provide the received video input signals V_IN_1, . . . , V_IN_n to the multiplexer 515. The multiplexer 515 may provide one of the video input signals V_IN_1, . . . , V_IN_n to the buffer 525, based on the operation mode of the video output system 500 or a position of an input port to which the video input signals V_IN_1, . . . , V_IN_n are inputted.

The reference signal generator 520 may generate a reference signal REF_SIG. The configuration and function of the reference signal generator 520 may be an exemplary embodiment in accordance with principles of inventive concepts, such as reference signal generators 120, 220, 320, and 420 in FIGS. 1 to 4. Therefore, the detailed description of the reference signal generator 520 will not be duplicated in detail here. The reference signal REF_SIG generated by the reference signal generator 520 may be provided to the buffer 525. In exemplary embodiments, the reference signal generator 520 may be implemented in the form of a variable voltage source capable of adjusting a level of an output voltage.

The buffer 525 may perform a buffering function such that an output of the multiplexer 515 and an output of the reference signal generator 520 are not affected by noise generated at an input terminal of the ADC 530. In addition, the buffer 525 may be used for impedance matching. The buffer 525 may provide the output of the multiplexer 515 and the output of the reference signal generator 520 to the ADC 530.

The ADC 530 may generate a video output signal V_OUT based on one of the video input signals V_IN_1, . . . , V_IN_n and the reference signal REF_SIG. The ADC 530 may be as described in exemplary embodiments of signal converters 110, 210, 310, and 410 in FIGS. 1 to 4 and detailed descriptions thereof will not be repeated here. In exemplary embodiments, the ADC 530 may receive a differential signal to minimize an influence of noise. One of the video input signals V_IN_1, . . . , V_IN_n and the reference signal REF_SIG may constitute a differential signal.

The offset/gain tuner 535 may tune an offset or a gain of the video output signal V_OUT generated by the ADC 530. The offset/gain tuner 535 may receive an offset tuning signal OFFSET and a gain tuning signal GAIN. The offset tuning signal OFFSET and the gain tuning signal GAIN may be generated by a user of the video output system 500. Alternatively, the offset tuning signal OFFSET and the gain tuning signal GAIN may be generated by a processor (not shown) in the video output system 500. The offset/gain tuner 535 may tune values of contrast, color, brightness, etc. of the video output signal V_OUT generated by the ADC 530, based on the offset tuning signal OFFSET and the gain tuning signal GAIN.

The offset controller 540 may receive the video output signal V_OUT. The offset controller 540 may refer to an observation signal included in the video output signal V_OUT. In accordance with principles of inventive concepts offset controller 540 may determine whether there is change in a level of the video input signals V_IN_1, . . . , V_IN_n, based on whether there is change in a code value of the observation signal. The offset controller 540 may generate an offset signal OFS_SIG depending on a result of the determination. In exemplary embodiments offset controller 540 may be an offset controller in accordance with principles of inventive concepts as described in reference to offset controllers 230, 330, and 430 in FIGS. 2 to 4 and the detailed descriptions thereof will not be repeated here. The offset signal OFS_SIG generated by the offset controller 540 may be provided to the reference signal generator 520. The reference signal generator 520 may generate the reference signal REF_SIG having a level adjusted based on the offset signal OFS_SIG.

The timing controller 545 may receive the video output signal V_OUT to be displayed on the display panel 555. The timing controller 545 may control an output of the video output signal V_OUT by distributing the video output signal V_OUT to the driver 550. In particular, when a size of the display panel 555 is large, the timing controller 545 may be used to prevent a time difference at the output of the video output signal V_OUT from occurring.

The driver 550 may receive the video output signal V_OUT, and signals HSYNC and VSYNC corresponding to a position where the video output signal V_OUT is displayed on the display panel 555. The driver 550 may drive the display panel 555 according to the received signals V_OUT, HSYNC, and VSYNC.

The display panel 555 may display the video output signal V_OUT based on a drive signal provided from the driver 550. The display panel 555 may include a transmissive display device such as a liquid crystal display (LCD). However, this is merely exemplary, and the display panel 555 may include a light-emissive display device such as an organic light emitting diode (OLED) and a plasma display panel (PDP). According to a utilization form of the video output system 500, the display panel 555 may include a reflective display device such as an electrophoretic display (EPD), an electro-wetting display (EWD), a photonic crystal display (PCD), and a micro electro-mechanical system (MEMS).

While the embodiments have been described with reference to exemplary embodiments, various changes and modifications may be made without departing from the spirit and scope of inventive concepts. Therefore, it should be understood that the above exemplary embodiments are not limiting, but illustrative.

What is claimed is:

1. A video signal processing device comprising:
a signal converter configured to generate a video output signal based on a video input signal and a reference signal; and
a reference signal generator configured to generate the reference signal that is responsive to a level change of the video input signal.

2. The video signal processing device as set forth in claim 1,
wherein the signal converter includes an analog-to-digital converter configured to receive a differential signal, and
wherein the differential signal is constituted by the video input signal and the reference signal.

3. The video signal processing device as set forth in claim 1, further comprising an offset controller configured to detect a change in the level of the video input signal provided to a position in which an observation signal included in the video output signal is outputted based on the observation signal and a signal corresponding to the position in which the observation signal is outputted, and to generate an offset signal when the level of the video input signal changes.

4. The video signal processing device as set forth in claim 3, wherein the signal converter generates the observation signal based on a signal in a back porch interval of the video input signal.

5. The video signal processing device as set forth in claim 3, wherein the offset controller samples the video output signal, according to a clock signal, to detect a change in the level of the video input signal.

6. The video signal processing device as set forth in claim 3, wherein the offset controller detects a change in the level of the video input signal based on whether there is change in a code value of the observation signal.

7. The video signal processing device as set forth in claim 6, wherein the offset controller detects an increase in the video input signal when the code value of the observation signal increases, and detects a decrease in the level of the video input signal when the code value of the observation signal decreases.

8. The video signal processing device as set forth in claim 7, wherein the offset signal includes information corresponding to whether at least one of the code value of the observation signal and the level of the video input signal increases or decrease and information corresponding to an increased or decreased amount of the code value of the observation signal.

9. The video signal processing device as set forth in claim 8, wherein the reference signal generator generates the reference signal having a level adjusted based on the offset signal.

10. The video signal processing device as set forth in claim 9, wherein the reference signal generator generates the reference signal having a level increased by a value corresponding to the increased amount of the code value of the observation signal when the level of the video input signal increases, and generates the reference signal having a level decreased by a value corresponding to the decreased amount of the code value of the observation signal when the level of the video input signal decreases.

11. A video signal processing method comprising:
generating a first video output signal based on a video input signal and a reference signal;
determining whether there is change in a level of the video input signal based on an observation signal included in the first video output signal;
generating a reference signal having a level adjusted to correspond with an amount of level change of the video input signal when the level of the video input signal changes; and
generating a second video output signal based on the video input signal and the reference signal having the adjusted level.

12. The video signal processing method as set forth in claim 11, wherein the determining includes determining whether there is change in the level of the video input signal based on whether there is change in a code value of the observation signal.

13. The video signal processing method as set forth in claim 12, wherein it is determined that the level of the video input signal increases when the code value of the observation signal increases, and it is determined that the level of the video input signal decreases when the code value of the observation signal decreases.

14. The video signal processing method as set forth in claim 13, further comprising generating an offset signal including information corresponding to whether at least one of the code value of the observation signal and the level of the video input signal increases or decrease and information corresponding to an increased or decreased amount of the code value of the observation signal,
wherein the generating the reference signal includes generating the reference signal having a level adjusted based on the offset signal.

15. The video signal processing method as set forth in claim 13, wherein the generating the reference signal includes generating the reference signal having a level increased by a value corresponding to the increased amount of the code value of the observation signal when the level of the video input signal increases, and includes generating the reference signal having a level decreased by a value corresponding to the decreased amount of the code value of the observation signal when the level of the video input signal decreases.

16. A method, comprising:
receiving an analog video signal;
generating an adjustable reference signal;
converting the analog video signal to a digital signal, by using the adjustable reference signal in an analog-to-digital converter; and
adjusting the adjustable reference signal according to variations in a non-image portion of the analog video signal.

17. The method of claim 16, wherein the non-image portion of the analog video signal is in a blanking interval.

18. The method of claim 17, wherein a voltage of the adjustable reference signal is increased or decreased with increasing or decreasing values, respectively, of a back porch segment of the blanking interval.

19. The method of claim 16, wherein a level of the adjustable reference signal level is set between upper and lower levels of the analog-to-digital converter's input range.

20. The method of claim 16, wherein the adjustable reference signal is adjusted according to a digitally-converted value of an output signal, and
the output signal is converted based on a differential signal comprising the analog video signal and the adjustable reference signal.
